(19) United States
(12) Patent Application Publication
(10) Pub. No.: US 2015/0334204 A1
(43) Pub. Date: Nov. 19, 2015

(54) INTELLIGENT AUTO-CACHING OF MEDIA

(71) Applicant: GOOGLE INC., Mountain View, CA (US)

(72) Inventors: Brandon Bilinski, San Francisco, CA (US); Alexander Collins, San Francisco, CA (US)

(73) Assignee: GOOGLE INC., Mountain View, CA (US)

(21) Appl. No.: 14/278,156

(22) Filed: May 15, 2014

(51) Int. Cl. H04L 29/08; G06F 3/0484

(52) U.S. Cl. CPC H04L 67/2857; G06F 3/04847; G06F 3/04842

(57) ABSTRACT

Techniques, systems, and computer readable media are provided that allow for portions of media items to be cached, prior to selection of any media item for playback by a user. The portion of a media item to be cached is determined based upon one or more caching factors, such as the likelihood that a user will select the media item for playback. Playback of a media item thus may begin without any noticeable buffering or caching, immediately upon selection of the media item by the user.

### BACKGROUND

Many media providing services include various search functionality, for example to allow a user to find content available on the service from a particular artist, composer, producer, album, or other source. Results of such a search are often presented in a list that allows the user to play part or all of the content of each result. For example, each result from a search performed at a music service may include a link that the user can select to begin playback of songs matching the user's search. However, there may be a delay between the time that a user selects such a link and the time that the content begins playing at the user's device. This may be true regardless of the amount of time that has elapsed between completion of the search, and selection of an item of content by the user. Such a delay may be undesirable to users, and may reduce the usefulness of the service and/or the search functionality for the user.

### BRIEF SUMMARY

Embodiments of the disclosed subject matter include techniques, systems, and computer readable media for caching media items prior to playback by a user. A list of media items to be presented to a user may be obtained and presented to the user. The list may be, for example, search results for a search executed at a content service by the user. One or more portions of one or more media items may be cached at the user's device. The duration and location of each cached portion may be determined based upon one or more caching factors. Example caching factors include a determined likelihood that the user will select the first media item; a timestamp when a vocal aspect of the first media item begins; a timestamp of a significant change in a waveform of the first media item; a portion of the first media item having a waveform with an amplitude above a threshold value; a rating of the media item; a play count of the media item, a number of playlists containing the media item, a tempo of the media item, a value stored in a comment field associated with the media item, a producer of the media item, a composer of the media item, and the contents of lyrics associated with the media item. Caching factors may be used individually or in any combination, and media items may be cached concurrently or consecutively. Each portion may be cached before receiving a selection of a media item for playback from the user. Upon receiving such a selection, a cached portion of the media item may be played. Additional portions of the media item may be played, such as by streaming or otherwise obtaining the remainder of the media item.

According to an embodiment of the disclosed subject matter, means for receiving a list of media items to be presented to a user and for presenting the media items to the user are provided. Means for caching a portion of one or more media items in the list based upon one or more caching factors are provided. Also provided are means for receiving a request from a user to play a media item that has been cached, and for playing the cached portion of the media item subsequent to a selection of the media item by the user.

Embodiments of the presently disclosed subject matter may allow for media items to be played immediately upon selection by a user, without any buffering or caching that is apparent to the user. Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process for caching media items according to an embodiment of the disclosed subject matter.

FIG. 2 shows an example system configuration according to an embodiment of the disclosed subject matter.

FIG. 3 shows an example computing device according to an embodiment of the disclosed subject matter.

### DETAILED DESCRIPTION

According to embodiments of the presently disclosed subject matter, when a user is presented with a list of media items such as songs that the user may want to play, various portions of one or more of the items may be cached before the user selects any items for playback. Most media players will begin buffering an item as soon as a user chooses to play the content. Embodiments of the presently disclosed subject matter may aggressively cache content that the user might want to play before they choose a particular item for playback, so that there is no buffering required. The portion of each item may be cached at a device of the user, based upon one or more caching factors. Similarly, the specific location within each item that is cached may be selected based upon one or more caching factors. For example, it may be desirable to cache portions of songs that include vocals, or that include portions of the songs identified as particularly interesting, such as crescendos, refrains, and the like. In some cases, it may be undesirable or infeasible to cache a large portion of every item that may be available to the user, especially in situations in which the items presented to the user are not known ahead of time. For example, when a user searches for content in a content service such as a music store, it may be more difficult to predict the songs or types of songs that the user is likely to play after the search, relative to a “suggested songs” interface in which the content presented to the user is known ahead of time. Embodiments of the presently disclosed subject matter provide improved techniques for identifying the portion and amount of media items to cache when a set of items are presented to the user, prior to the user selecting any of the items for playback.

In conventional content distribution systems such as music or movie stores, when a user performs a search, most applications will search over the corpus of artists, albums, songs, genres, playlists, and so on, and will return a set of matching results. The results may have basic metadata (album art, title, artist), a link to either the navigational page (in the case of an artist, album, genre or playlist), and a link to the first audio or video file. In some cases, when search results are returned to a user interface, the interface may begin caching the first items in the results so as to make them more readily available should the user choose to play them. However, this may be inefficient, for example if the user does not select one of the initial results. According to embodiments of the presently disclosed subject matter, a portion of each media file returned in the results may be cached, starting with the most relevant items. The portion cached may be at the beginning of a media item, or it may be located somewhere in the middle of the media item.

The duration of each media item to be cached may be determined in several ways. For example, a technique may attempt to cache a portion of each item in the list of items, such as a list of search results, which are presented to the user. To do so, the amount of time that it takes a user to select an item in the list may be determined, such as based upon an historical average selection time for the user or for a group of users. The expected amount of time before a selection may then be divided evenly among the items in the list presented to the user. For example, if it takes a user 5 seconds on average to select an item for playback, and a list of items presented to the user includes 10 items, 500 ms may be spent caching as much of each item in the list as possible.

As another example, the amount of each media item to be cached may be determined based upon the size of a buffer used by a media player at the user's device. Most media players will start buffering a song or video for a specific number of seconds before playback starts. An amount of each media item may be cached equal to the buffer of the media player, starting with a most relevant item and working down in terms of relevance, as disclosed in further detail herein. Thus, when one of the media items is selected, playback may begin without the initial buffering being apparent to the user.

Another technique is to cache those media items that are most likely to be selected by the user. The likelihood of a user selecting a particular item may be determined based on, for example, users' selections of items tied to a query similar to a query that generated the list of media items presented to the user. As a specific example, if, when users search for the song “Wrecking Ball”, they are 80% likely to play the Miley Cyrus song, 15% likely to play a karaoke version, and 5% likely to play an instrumental version, the corresponding versions of the song may be cached in that order. Similarly, the likelihood of a user selecting a particular song may be based upon historical actions of the individual user. For example, a user may have previously selected several media items corresponding to movie trailers. If the user performs a search for “Iron Man,” the search results may include a version of the song “Iron Man,” the movie “Iron Man,” and a trailer for the movie “Iron Man 2.” Based on the user's history, the trailer for “Iron Man 2” may be cached preferentially over the song and the movie.

Another technique is to cache content while a user is completing a purchase of one or more content items. For example, if a user is buying a song or video through a content providing service, as the user is completing payment, the beginning of the content being purchased may be cached. Thus playback of the content may begin as soon as the user completes the purchase, without any delay apparent to the user.

As with the duration of a media item, the specific portion of a media item to be cached may be determined based upon several factors. For example, it may be desirable to cache a portion of the media item that includes a section of the item that is believed to be interesting to a user, such as a portion of a song that includes lyrics, a particularly loud or fast portion of a song, or the like. Such portions of a media item may be identified, for example, by determining beginning and end segments of a song that include lyrics, based on an analysis of the audio content of the song, known lyrics and/or time cues within the song, or the like. As another example, a waveform of a media item may be analyzed to identify a portion of the item that has many changes in a short period of time or a significant change in the waveform, or that has an amplitude over a threshold such as relative to the average amplitude of the media item.

Other caching factors may be used to determine the location and/or duration of a media item to cache. For example, metadata related to the media item in a media service may be used, such as a rating, play count, and/or number of playlists containing the media item. Generally, it may be determined that the more popular or higher-rated a media item is by the user or by other users, the more likely the user is to select the item for playback. Thus, a higher popularity or rating may indicate that the media item should be cached ahead of less popular or lower-rated items, and/or that a larger portion of the media item should be cached. Other metadata related to the content of the media item also may be used, such as the tempo, producer, composer, or artist of the media item, the contents of lyrics in the media item, and/or values stored in comment fields associated with the media item. For example, media items having metadata that indicate the media item is more likely to be played, based on historical user selections, may be cached earlier and/or more extensively.

In general, one or more caching factors may be used alone or in conjunction with other caching factors to determine the extent of, and order in which, media items in a particular list are to be cached. Different caching factors also may be used sequentially. For example, an initial portion of one or more media items may be cached based upon the likelihood that a user will select the media item. If the user has not yet selected a media item for playback when this initial caching is completed, one or more of the media items may be cached further, or additional media items may be partially or entirely cached, based upon the popularity of the items or any other caching factor.

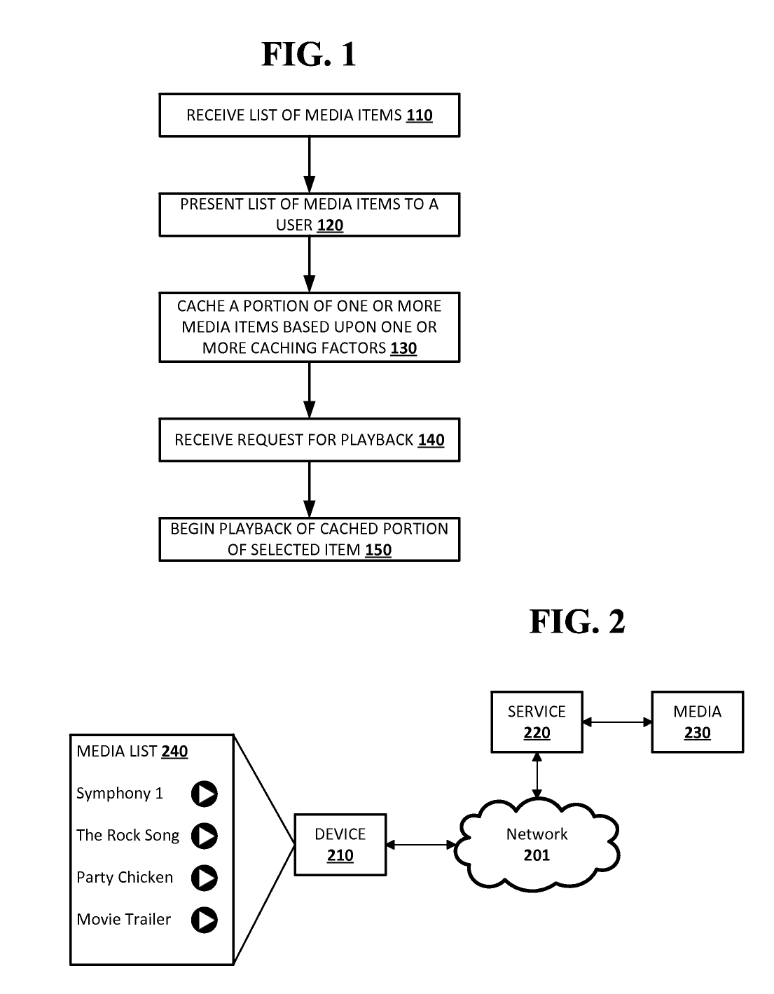

FIG. 1 shows an example technique for caching media items in a list of media items presented to a user, such as by a content providing service. At 110, a list of media items to be presented to a user may be obtained. The list may be, for example, a list of search results for a search performed by the user at a content providing service, or an automatically-generated list of items such as “suggested” media items, an existing playlist, or the like, that has been accessed by the user. At 120, the list may be presented to the user, such as via a user interface accessed by the user. In some configurations, the list may be transmitted to a device of the user, such as a mobile phone, tablet, laptop or desktop computer, or the like, on which a media player is installed or presented to the user. As a specific example, the user may access the list and subsequent playback features via a web browser or similar application on the user's device, which is in communication with a remote content service that provides the list of media items and from which the user's device may obtain and cache content.

At 130, a portion of one or more media items in the list may be cached. In some configurations the media items may be cached before the list is presented to the user. However, typically the list will be presented relatively quickly, such that little or no caching may be performed before the list is presented to the user. Notably, one or more media items may be partially or entirely cached at a device of the user before the user selects any one of the media items for playback on the device. Thus, when the user selects a particular media item for playback, it may begin playing on the user's device immediately, without any apparent buffering from the perspective of the user. The duration and location of each portion of each media item to be cached may be determined based upon multiple factors, as previously described. Generally, each cached portion may have a duration and a location within the media item that is selected based upon one or more caching factors. Example caching factors used to select the duration and position of a cached portion of a media item may include the likelihood that the user will select the media item for playback, a timestamp of a vocal aspect of the media item, a significant audio change or other change in the waveform of the media item, and a location of the media item having a waveform amplitude above a threshold amount. One or more caching factors may be used to select the portion of each media item for which a portion is cached, as well as the specific media items that are cached and the order in which they are cached. In some configurations, multiple media items in the list may be cached consecutively or concurrently, for example based upon the bandwidth available for caching, the duration and bitrate of the individual media items, and the like.

At 140, a request for playback of a media item may be received from the user, such as a selection of the media item or a user interface element associated with the media item. In response, the selected media item may be played, beginning with the cached portion of the media item. Subsequently, additional portions of the media item may be obtained while the cached portion is playing, and “stitched” together upon reaching the end of the cached portion, as is known in the art. In some configurations, subsequent portions of the media item may be obtained at a higher bitrate than the initial cached portion. For example, if additional bandwidth is available, or if it is determined that the additional portions may be streamed from a remote content service without interruption, a higher-quality version of the media item may be streamed or otherwise played after the initial cached portion has finished playing.

FIG. 2 shows an example system according to an embodiment of the disclose subject matter. A user device 210, such as a smart phone, tablet, laptop computer, or the like, may communicate with a media service, such as a music and/or video store 220. The device 210 may communicate with the service via a network 201 such as the Internet, using any conventional protocols and network connections. The content service 220 may be in communication with, or may include, one or more media sources 230. For example, the service 220 may make content from a variety of content producers available to user devices 210 through a marketplace or similar service. The media 230 may include various metadata as previously described, such as metadata describing the content, quality, audio and/or video attributes, and other attributes of media items provided by the service 220 to user devices 210.

The user device 210 may provide an interface 240 that is capable of displaying lists of media items to the user. Such a list may include graphics and/or text that identifies each media item, as is readily understood in the art. Each item in the list may be selectable by the user, such as via a touch screen or conventional computer interface that allows a user to tap, click, or otherwise select each item. As previously described, after the list 240 is presented to a user and before the user selects one of the media items in the list 240 for playback, a portion of one or more of the media items may be cached. For example, if it is determined that the song “Symphony 1” is more likely to be played by the user than “Party Chicken,” it may be cached first, and/or a larger portion of “Symphony 1” may be cached. The determination of which portions of which media items to cache may be made by the user device 210, the service 220, or a combination thereof. For example, the media service 220 may provide metadata as previously described, which the device 210 may use to determine which media items to cache, in what order, and/or what portions of the media items to cache. Similarly, the media service 220 may provide an indication such as a ranking for each media item listed in the interface 240 that indicates to the device 210 which media items should be cached, in what order, and/or the portion of each media item to cache. As a specific example, a search process or other process operating on the device 210 or the service 220 may return an indication, such as a URL, of the media items in the list. The items may be returned in relevancy order, such as most-relevant results first, where the relevancy order is determined based upon the caching factors previously described. As a specific example, the relevancy order may indicate the likelihood that the user will select each media item in the list. A list of key-value pairs including pointers to the search results and portions of cached media items may be created and provided to the user device 210. If a user starts to play a song on the search results page, the cached media item, the URL to the full item, and the duration of the item may be provided to the media player. The media player may then stitch the cached portion together with the full media item based on the duration of the portion. As a user is selecting which of the items in the list to play, additional portions of media items in the list may be obtained and cached at the device 210. Thus, when a user selects another media item for playback, the item may begin immediately and continue with no buffering. More generally, the user device 210 may receive a list of media items and associated rankings and caching data that allow the device 210 to cache portions of the media items from the media service 220 before the user selects one or more of the media items for playback.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity and/or search history may be treated so that no personally identifiable information can be determined for the user, or a user's media preferences may be generalized so that a particular purchase history of a user cannot be determined. Thus, the user may have control over how information is collected about the user and used by a system as disclosed herein.

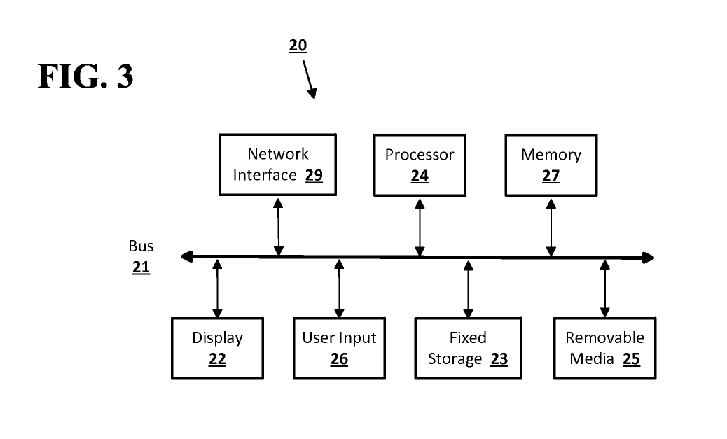

Embodiments of the presently disclosed subject matter may be implemented in and used with a variety of component and network architectures. FIG. 3 is an example computing device 20 suitable for implementing embodiments of the presently disclosed subject matter, such as a portable computing device or a media service as disclosed herein. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving a list of media items to be presented to a user;
presenting the list of media items to the user;
for at least a first media item in the list of media items to be presented to a user, caching a portion of the first media item at a device of the user, wherein the portion of the first media item is determined based upon at least a first caching factor selected from the group consisting of: a determined likelihood that the user will select the first media item; a timestamp when a vocal aspect of the first media item begins; a timestamp of a significant change in a waveform of the first media item; and a portion of the first media item having a waveform with an amplitude above a threshold value;
receiving a request from the user to play the first media item in the list of media items; and
in response to the request from the user to play the first media item, playing the first media item beginning with the cached portion of the media item.

2. The method of claim 1, wherein, for at least a second media item in the list of media items, the portion of the second media item cached at the device of the user is further determined based upon at least a second caching factor selected from the group consisting of: a timestamp when a vocal aspect of the second media item begins; a timestamp of a significant change in a waveform of the second media item; and a portion of the second media item having a waveform with an amplitude above a threshold value.

3. The method of claim 1, wherein, for the first item in the list of media items, the portion of the first media item cached at the device of the user is further determined based upon at least a second caching factor selected from the group consisting of: a determined likelihood that the user will select the media item; a timestamp when a vocal aspect of the first media item begins; a timestamp of a significant change in a waveform of the first media item; and a portion of the first media item having a waveform with an amplitude above a threshold value;
wherein the second caching factor is different than the first caching factor.

4. The method of claim 1, wherein, for at least one media item in the list of media items, the portion of the media item cached at the device of the user is further determined based upon at least a second caching factor selected from the group consisting of: a rating of the media item; a play count of the media item, a number of playlists containing the media item, a tempo of the media item, a value stored in a comment field associated with the media item, a producer of the media item, a composer of the media item, and the contents of lyrics associated with the media item.

5. The method of claim 1, wherein the list of media items to be presented to the user comprises a plurality of search results of a search executed by the user.

6. The method of claim 1, further comprising:
receiving an additional portion of the first media item subsequent to the cached portion of the media item;
playing the additional portion of the first media item in a continuous playback subsequent to the cached portion of the media item.

7. The method of claim 1, wherein the portion of the media item is the initial portion of the media item.

8. The method of claim 1, wherein the portion of the media item is cached at a first bitrate, and wherein a subsequent portion of the media item is played at a second bitrate different than the first bitrate.

9. The method of claim 1, further comprising:
identifying a projected set of media items of which it is determined that the user is likely to request playback;
for at least a second media item in the projected set of media items, caching a portion of the second media item at the device of the user.

10. The method of claim 9, wherein the position of the portion within the second media item is determined based upon at least a second caching factor selected from the group consisting of: a determined likelihood that the user will select the second media item; a timestamp when a vocal aspect of the second media item begins; a timestamp of a significant change in a waveform of the second media item; and a portion of the second media item having a waveform with an amplitude above a threshold value.

11. The method of claim 1, wherein the duration of the portion of the first media item is selected based upon the determined likelihood that the user will select the first media item.

12. The method of claim 1, wherein the position of the portion of the first media item within the first media item is determined based upon an attribute of the waveform of the first media item.

13. The method of claim 1, wherein the portion of the first media item is cached at a device of the user prior to the request from the user to play the first media item.

14. The method of claim 13, wherein a portion of a plurality of media items in the list of media items is cached at the device of the user prior to the request from the user to play the first media item.

15. The method of claim 14, wherein the duration of the portion of each of the plurality of media items is independently determined based upon a determined likelihood that the user will select the media item.

16. A computing device comprising:
a computer-readable memory;
a processor configured to:
receive a list of media items to be presented to a user;
present the list of media items to the user;
for at least a first media item in the list of media items to be presented to a user, cache a portion of the first media item on the computer-readable memory, wherein the portion of the first media item is determined based upon at least a first caching factor selected from the group consisting of: a determined likelihood that the user will select the first media item; a timestamp when a vocal aspect of the first media item begins; a timestamp of a significant change in a waveform of the first media item; and a portion of the first media item having a waveform with an amplitude above a threshold value;
receive a request from the user to play the first media item in the list of media items; and
in response to the request from the user to play the first media item, play the first media item beginning with the cached portion of the media item on the device.

17. The device of claim 16, wherein, for at least one media item in the list of media items, the portion of the media item cached at the device is further determined based upon at least a second caching factor selected from the group consisting of: a rating of the media item; a play count of the media item, a number of playlists containing the media item, a tempo of the media item, a value stored in a comment field associated with the media item, a producer of the media item, a composer of the media item, and the contents of lyrics associated with the media item.

18. The device of claim 16, wherein the list of media items to be presented to the user comprises a plurality of search results of a search executed by the user.

19. The device of claim 16, said processor further configured to:
identify a projected set of media items of which it is determined that the user is likely to request playback;
for at least a second media item in the projected set of media items, cache a portion of the second media item on the computer-readable memory.

20. A computer-readable storage device comprising instructions which, when executed by a computing device, cause the computing device to:
receive a list of media items to be presented to a user;
present the list of media items to the user;
for at least a first media item in the list of media items to be presented to a user, cache a portion of the first media item, wherein the portion of the first media item is determined based upon at least a first caching factor selected from the group consisting of: a determined likelihood that the user will select the first media item; a timestamp when a vocal aspect of the first media item begins; a timestamp of a significant change in a waveform of the first media item; and a portion of the first media item having a waveform with an amplitude above a threshold value;
receive a request from the user to play the first media item in the list of media items; and
in response to the request from the user to play the first media item, play the first media item beginning with the cached portion of the media item.
